(19) United States
(12) Patent Application Publication
(10) Pub. No.: US 2014/0379459 A1
(43) Pub. Date: Dec. 25, 2014

(54) SOFTWARE SYSTEM WHICH PRESENTS DATA ABOUT THE USED AND THE AVAILABLE HOSTING RESOURCES OF A COMPUTING DEVICE AS WELL AS THE PRICING OF HOSTING RESOURCES THAT NEED TO BE PURCHASED FOR ENSURING THE PROPER OPERATION OF SOFTWARE APPLICATIONS INSTALLED ON A COMPUTING DEVICE

(71) Applicant: Feodor Weissmann, Tel Aviv (IL)

(72) Inventor: Feodor Weissmann, Tel Aviv (IL)

(21) Appl. No.: 14/313,687

(22) Filed: Jun. 24, 2014

Related U.S. Application Data
(60) Provisional application No. 61/839,257, filed on Jun. 25, 2013.

(51) Int. Cl. G06Q 30/02; G06F 11/30; G06F 15/177

(52) U.S. Cl. CPC G06Q 30/0283; G06Q 30/0243; G06F 15/177; G06F 11/3065
USPC 705/14.42

(57) ABSTRACT

A software system which visually presents data about the used and available hosting resources of the computing device or devices specified by the user of invention via an user application as well as data about the pricing of the hosting resources that need to be purchased for ensuring the proper operation of software applications installed on the computer device or devices specified by the user of invention via an user application.

### CROSS-REFERENCE TO RELATED APPLICATIONS

This patent application claims the benefit of provisional patent application 61/839257, filed on Jun. 25, 2013 by the present inventor.

### BACKGROUND

### Prior Art

The following is a tabulation of some prior art that presently appears relevant.

| Patent Number | Kind Code | Issue Date | Patentee |
|---|---|---|---|
| 8,656,018 | B1 | Feb. 18, 2014 | Keagy, et al. |
| 8,468,535 | B1 | Jun. 18, 2013 | Keagy, et al. |
| 8,451,755 | B2 | May 28, 2013 | Chin |
| 8,352,608 | B1 | Jan. 8, 2013 | Keagy, et al. |

The existing prior art includes various inventions related to the management of hosting resources. For example, U.S. Pat. No. 8,656,018 to Keagy, et al. provides a method for automatedly allocating hosting resources controlled by different hypervisors. A second example of an invention related to the management of hosting resources can be found in U.S. Pat. No. 8,451,755 to Chin. The U.S. Pat. No. 8,451,755 provides a method of allocating telecommunications conference hosting resources for the management of a conferencing function. A third example of an invention related to the management of hosting resources can be found in U.S. Pat. No. 8,364,802 to Keagy, et al. The U.S. Pat. No. 8,364,802 provides for a system and method for monitoring a grid of hosting resources in order to facilitate management of the hosting resources. A fourth example of an invention related to the management of hosting resources can be found in U.S. Pat. No. 8,352,608 to Keagy, et al. The U.S. Pat. No. 8,352,608 provides for a system and method for automated configuration of hosting resources.

The aforementioned inventions do not provide their users with information about the prices of hosting resources that need to be purchased for ensuring the proper operation of software applications installed on a computing device. Therefore, there is a need for an invention that facilitates the management of hosting resources by providing the users of the invention with information about the prices of hosting resources that need to be purchased for ensuring the proper operation of software applications installed on a computing device. Such an invention will facilitate the purchase of hosting resources which are necessary for the operation of the software applications installed on a computing device. Moreover, if the prices of the hosting resources are provided by different hosting providers, such an invention will ensure that the user of the invention purchases the most cost-effective hosting resources.

### SUMMARY

In one embodiment, the present invention consist of an user application, a node controller application, modulation array nodes, a modulation array controller, a system monitoring database, a correlation engine, and a business activity database.

On a request of the user, the user application visually presents data about the used and the available hosting resources of the computing device or devices specified by the user of the invention via an user application as well as data about the pricing of the hosting resources that need to be purchased for ensuring the operation of software applications installed on the computing device or devices specified by the user of the invention via an user application. Hosting resources are a set of computing resources located on single or multiple servers allowing the execution of network applications.

On a request of the user application, a node controller application sends requests for performance data to one or more modulation array nodes and sends the received performance data to a modulation array controller. The performance data includes data about the quality of the connection between computing device or devices specified by the user of the invention via the user application and computing device or devices on which one or more of the modulation array nodes are located.

On a request of the node controller application, modulation array nodes send performance data to the node controller application. Then, the node controller application sends the performance data to the modulation array controller.

After receiving performance data from the node controller application, the modulation array controller stores the received performance data in a system monitoring database and sends the received performance data to the user application.

The system monitoring database stores performance data provided by the modulation array controller and, on a request of a correlation engine, sends the requested performance data to a correlation engine.

After receiving a request from the user application, the correlation engine correlates the data from a system monitoring database with the data from a business activity database and, afterwards, submits the correlated data to the user application.

On a request of the correlation engine, a business activity database sends data about the pricing of hosting resources to the correlation engine.

### ADVANTAGES

The main advantage of the invention is that it allows the user of the invention to know the quantities and the prices of the hosting resources that need to be purchased for ensuring the operation of the software applications installed on a computing device or devices specified by the user of the invention via the user application. The prices are provided by different hosting providers. It allows the user to purchase the most cost-effective hosting resources.

### DRAWINGS—FIGURES

FIG. 1 is a schematic diagram illustrating one embodiment of the invention.

FIG. 2 is a flowchart illustrating in detail an exemplary process of operation of the Modulation Array Controller

FIG. 3 is a flowchart illustrating in detail an exemplary process of operation of the Correlation Engine

### DRAWINGS—REFERENCE NUMERALS

10 User Application

20 Node Controller Application

30 Modulation Array Nodes

40 Modulation Array Controller

50 System Monitoring Database

60 Correlation Engine

70 Business Activity Database

80 start of the exemplary process of operation of the Modulation Array Controller

90 by using the User Application, the user selects: (i) the Modulation Array Nodes from which he would like to receive information; (ii) URL; and (iii) other parameters;

100 the User Application submits the information about the selected Modulation Array Nodes, the URL, and the other parameters to a Node Controller Application

110 the Node Controller Application requests the selected Modulation Array Nodes to send the performance data to the Node Controller Application

120 the Modulation Array Nodes send the performance data to the Node Controller Application

130 the Node Controller Application sends the performance data to the Modulation Array Controller

140 the Modulation Array Controller stores the performance data on a System Monitoring Database

150 the Modulation Array Controller sends the performance data to the User Application

160 the User Application displays the performance data to the user

170 end of the exemplary process of operation of the Modulation Array Controller

180 start of an exemplary process of operation of the Correlation Engine

190 by using the User Application, the user sends a request for correlation of data

200 the User Application sends the request for correlation of data to the Correlation Engine

210 the Correlation Engine correlates the data in a System Monitoring Database and a Business Activity Database

220 the Correlation Engine sends the correlated data to the User Application

230 the User Application displays the correlated data to the user

240 end of an exemplary process of operation of the Correlation Engine

### DETAILED DESCRIPTION

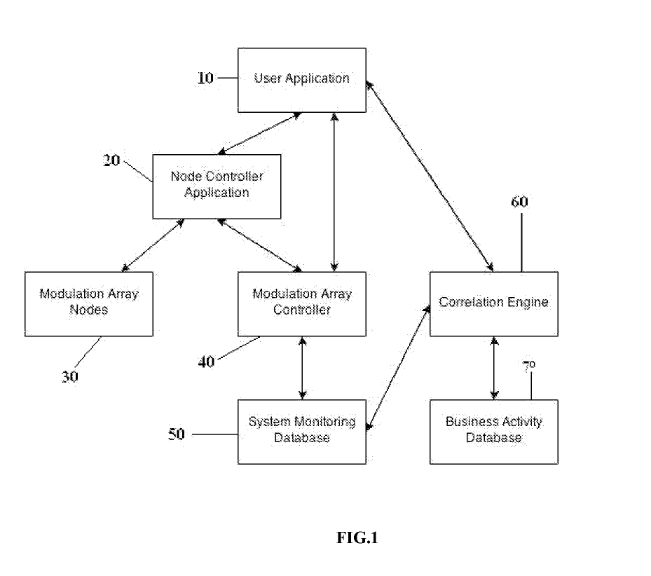

### FIG. 1—First Embodiment

One embodiment of the present invention is illustrated in FIG. 1. The embodiment described in FIG. 1 consists of at least seven components, namely, User Application 10, Node Controller Application 20, Modulation Array Nodes 30, Modulation Array Controller 40, System Monitoring Database 50, Correlation Engine 60, and a Business Activity Database 70.

The User Application 10, the Node Controller Application 20, the Modulation Array Controller 40, the System Monitoring Database 50, the Correlation Engine 60, and the Business Activity Database 70 are located on a single computing device. The Modulation Array Nodes 30 are located on various computing devices, including, but not limited to, desktop computing device and mobile computing devices.

The embodiment is able to be implemented, for example, using a machine-readable medium or article which is able to store an instruction or a set of instructions that, if executed by a machine, cause the machine to perform the operations described herein. Such machine is able to include, for example, any suitable processing platform, computing platform, computing device, processing device, electronic device, electronic system, computing system, processing system, computer, processor, or the like, and is able to be implemented using any suitable combination of hardware and/or software.

The machine-readable medium or article is able to include, for example, any suitable type of memory unit, memory device, memory article, memory medium, storage device, storage article, storage medium and/or storage unit; for example, memory, removable or non-removable media, erasable or non-erasable media, write-able or re-write-able media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like.

The instructions are able to include any suitable type of code, for example, source code, compiled code, interpreted code, executable code, static code, dynamic code, or the like, and are able to be implemented using any suitable high-level, low-level, object-oriented, visual, compiled and/or interpreted programming language, e.g., C, C++, Java, BASIC, Pascal, Fortran, Cobol, assembly language, machine code, or the like. Functions, operations, components and/or features described herein with reference to one or more embodiments, is able to be combined with, or is able to be utilized in combination with, one or more other functions, operations, components and/or features described herein with reference to one or more other embodiments, or vice versa.

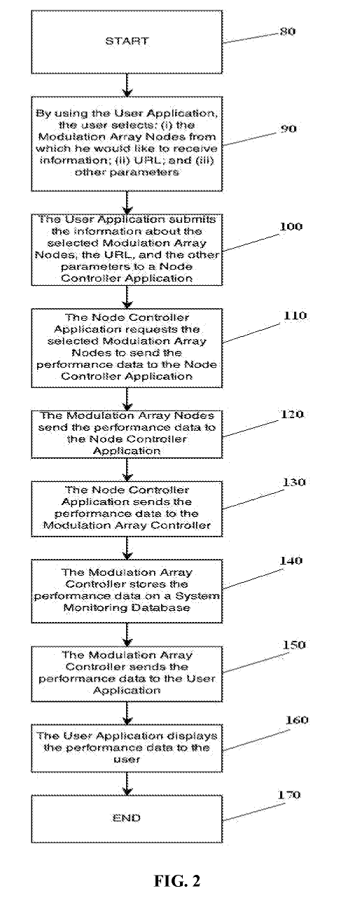

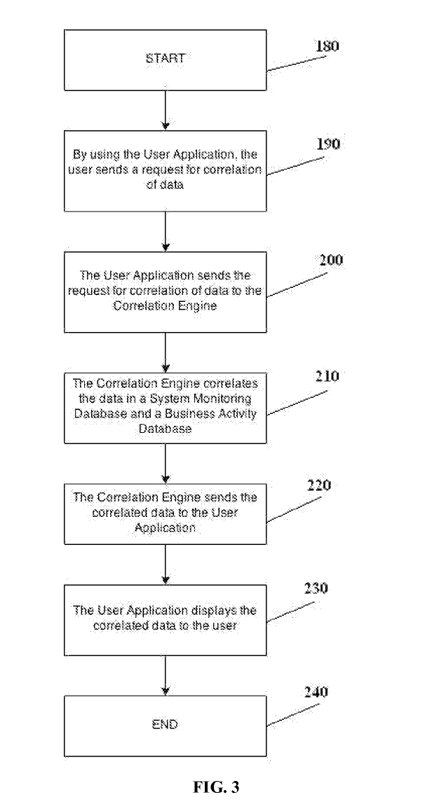

### Operation—FIGS. 2 and 3

By using the User Application 10, the user of the invention can choose whether to start the exemplary process of operation of the Modulation Array Controller 40 or start the exemplary process of operation of the Correlation Engine 60.

FIG. 2 describes the exemplary process of operation of the Modulation Array Controller. At step 80, the user starts the exemplary process of operation of the Modulation Array Controller. At step 90, the user selects, by using the User Application 10, (i) the Modulation Array Nodes 30 from which he would like to receive information; (ii) the uniform resource locator (URL); and (iii) other parameters. At step 100, the User Application 10 submits the information about the selected Modulation Array Nodes 30, the URL, and the other parameters to a Node Controller Application 20. At step 110, the Node Controller Application 20 requests the selected Modulation Array Nodes 30 to send the performance data to the Node Controller Application 20.

The performance data includes data about: (i) the speed of the Internet connection between computing device or devices specified by the user of the invention via the User Application 10 and computing device or devices on which one or more of the Modulation Array Nodes 30 are located; (ii) the time it takes of computing device or devices specified by the user of the invention via the User Application 10 to respond through TCP/IP (Transmission Control Protocol/Internet Protocol) or UDP (User Datagram Protocol) to the computing device or devices on which one or more of the Modulation Array Nodes 30 are located; (iii) connection errors which appear during the exchange of information through TCP/IP (Transmission Control Protocol/Internet Protocol) or UDP (User Datagram Protocol) between computing device or devices specified by the user of the invention via the User Application 10 and the computing device or devices on which one or more of the Modulation Array Nodes 30 are located; (iv) the rate of successful message delivery over the communication channel between computing device or devices specified by the user of the invention via the User Application 10 and computing device or devices on which one or more of the Modulation Array Nodes 30 are located; (v) the retransmission connection attempts through TCP/IP (Transmission Control Protocol/Internet Protocol) or UDP (User Datagram Protocol) between computing device or devices specified by the user of the invention via the User Application 10 and computing device or devices on which one or more of the Modulation Array Nodes 30 are located; (vi) timeouts in the TCP/IP (Transmission Control Protocol/Internet Protocol) or UDP (User Datagram Protocol) connection between computing device or devices specified by the user of the invention via the User Application 10 and computing device or devices on which one or more of the Modulation Array Nodes 30 are located; (vii) routing paths applying to the TCP/IP (Transmission Control Protocol/Internet Protocol) or UDP (User Datagram Protocol) connection between computing device or devices specified by the user of the invention via the User Application 10 and computing device or devices on which one or more of the Modulation Array Nodes 30 are located; (viii) the number of hops in the TCP/IP (Transmission Control Protocol/Internet Protocol) or UDP (User Datagram Protocol) connection between computing device or devices specified by the user of the invention via the User Application 10 and computing device or devices on which one or more of the Modulation Array Nodes 30 are located; (ix) the time required for Internet Protocol (IP) packets to travel through the TCP/IP (Transmission Control Protocol/Internet Protocol) or UDP (User Datagram Protocol) connection from a computing device or devices on which one or more of the Modulation Array Nodes 30 are located to and back from a computing device or devices specified by the user of the invention via the User Application 10.

The URL and the other parameters provided by the user in step 90 are used for specifying the type of requested performance data. At step 120, the Modulation Array Nodes 30 send the performance data to the Node Controller Application 20. In order to receive the requested performance data, the Modulation Array Nodes 30 test the quality of the connection between computing device or devices specified by the user of the invention via the User Application 10 and computing device or devices on which one or more of the Modulation Array Nodes 30 are located. At step 130, the Node Controller Application 20 sends the performance data to the Modulation Array Controller 40. At step 140, the Modulation Array Controller 40 stores the performance data on a System Monitoring Database 50. The System Monitoring Database 50 contains the performance data requested by the user of the invention.

At step 150, the Modulation Array Controller 40 sends the performance data to the User Application 10. At step 160, the User Application 10 displays the performance data to the user. At step 170, the exemplary process of operation of the Modulation Array Controller 40 ends.

FIG. 3 describes the exemplary process of operation of the Correlation Engine 60. At step 180, the user starts the exemplary process of operation of the Correlation Engine 60. At step 190, the user, by using the User Application 10, sends a request for correlation of data. At step 200, the User Application 10 sends the request for correlation of data to the Correlation Engine 60. At step 210, the Correlation Engine 60 correlates the data in a System Monitoring Database 50 and a Business Activity Database 70. The Business Activity Database 70 contains data about the prices of hosting resources offered by different hosting providers, actual price of computer hardware and software purchased by the user of the invention, number of visitors of the website of the user of the invention, numbers of clicks on the website of the user of the invention, data on advertising campaigns generating traffic to the website of the user of the invention, marketing steps taken by the user of the invention, actions taken by visitors on the website of the user of the invention. The data in the Business Activity Database 70 can be either manually inserted by the administrator of the software application or automatically collected through software applications. At step 220, the Correlation Engine 60 sends the correlated data to the User Application 10. At step 230, the User Application 10 displays the correlated data to the user. In particular, at step 230, the User Application 10 visually presents pricing of the hosting resources that need to be purchased for ensuring the operation of the software applications installed on computing device or devices specified by the user of the invention via the User Application 10. At step 240, the exemplary process of operation of the Correlation Engine 60 ends.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A system which visually presents data about the used and available hosting resources of at least one computing device specified by the user of the system via an user application as well as the pricing of hosting resources that need to be purchased for ensuring the proper operation of software applications installed on the said computing device, the system comprising of:
an user application, which on a request of the user, visually presents data about the used and available hosting resources of the said computer device as well as data about the pricing of the hosting resources that need to be purchased for ensuring the operation of software applications installed on the said computing device; and
a node controller application that, on a request of the user application, sends requests for receiving data about the used and the available hosting resources of the said computing device to a modulation array node located on the said computing device and sends the received data to a modulation array controller; and
modulation array node that, on a request of the node controller application, tests the used and available hosting resources of the said computing device and sends to the node controller application the collected information about used and available hosting resources of the said computing device; and
a modulation array controller that, after receiving data about the used and the available hosting resources of the said computing device from the node controller application, stores the received data in a system monitoring database and sends the received data to the user application; and
a system monitoring database storing data about the used and available hosting resources of the said computing device provided by the modulation array controller and, on a request of a correlation engine, sends the requested data to a correlation engine; and
a correlation engine that, after receiving a request from the user application, correlates the data from a system monitoring database with the data from a business activity database and, afterwards, submits the correlated data to the user application; and
a business activity database that, on a request of the correlation engine, sends to the correlation engine data about the prices of hosting resources offered by different hosting providers, actual price of computer hardware and software purchased by the user of the system, number of visitors of the website of the user of the system, numbers of clicks on the website of the user of the system, data on advertising campaigns generating traffic to the website of the user of the system, marketing steps taken by the user of the system, actions taken by visitors on the website of the user of the system.

2. The system according to claim 1, wherein the data in the business activity database is inserted manually by the administrator of the system.

3. The system according to claim 1, wherein the data in the business activity database is inserted automatically through other software applications.

4. The system according to claim 1, wherein, on a request of the user of the invention, the prices of the hosting resources are provided by different hosting providers.
